(19) United States
(12) Patent Application Publication
(10) Pub. No.: US 2026/0089078 A1
(43) Pub. Date: Mar. 26, 2026

(54) TECHNOLOGIES FOR LOGICAL CHANNEL PRIORITY ADJUSTMENT

(71) Applicant: Apple Inc., Cupertino, CA (US)

(72) Inventors: Ping-Heng Kuo, London (GB); Haijing Hu, Los Gatos, CA (US); Ralf Rossbach, Munich (DE)

(73) Assignee: Apple Inc., Cupertino, CA (US)

(21) Appl. No.: 19/306,969

(22) Filed: Aug. 21, 2025

Related U.S. Application Data
(60) Provisional application No. 63/698,428, filed on Sep. 24, 2024.

(51) Int. Cl. H04L 43/087; H04L 49/90

(52) U.S. Cl. CPC H04L 43/087; H04L 49/9026

(57) ABSTRACT

The present application relates to devices and components including apparatus, systems, and methods for adjusting a logical channel priority.

### CROSS-REFERENCE TO RELATED APPLICATION

This application claims priority to U.S. Provisional Patent Application No. 63/698,428, entitled “TECHNOLOGIES FOR LOGICAL CHANNEL PRIORITY ADJUSTMENT,” filed on Sep. 24, 2024, which is herein incorporated by reference in its entirety for all purposes.

### TECHNICAL FIELD

This application relates generally to communication networks and, in particular, to technologies for logical channel priority adjustment in wireless networks.

### BACKGROUND

Third Generation Partnership Project (3GPP) Technical Specifications (TSs) define standards for wireless networks. These TSs describe aspects related to signaling traffic through systems that incorporate wireless networks.

### BRIEF DESCRIPTION OF THE DRAWINGS

FIG. 1 illustrates a network environment in accordance with some embodiments.

FIG. 2 illustrates a logical channel configured with priorities in accordance with some embodiments.

FIG. 3 illustrates an example procedure in accordance with some embodiments.

FIG. 4 illustrates another example procedure in accordance with some embodiments.

FIG. 5 illustrates another example procedure in accordance with some embodiments.

FIG. 6 illustrates an example data flow in accordance with some embodiments.

FIG. 7 illustrates another example procedure in accordance with some embodiments.

FIG. 8 illustrates an operation flow/algorithmic structure in accordance with some embodiments.

FIG. 9 illustrates another operation flow/algorithmic structure in accordance with some embodiments.

FIG. 10 illustrates another operation flow/algorithmic structure in accordance with some embodiments.

FIG. 11 illustrates a user equipment in accordance with some embodiments.

FIG. 12 illustrates a network device in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

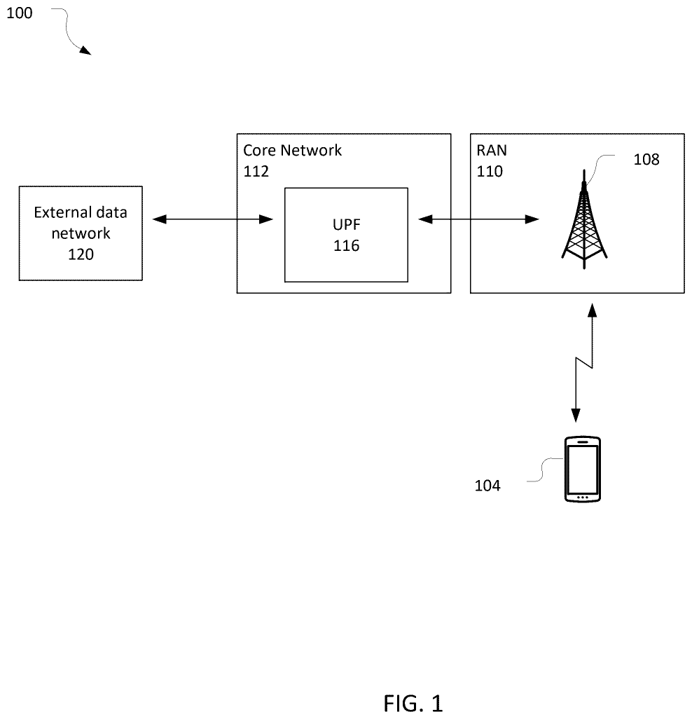

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP TSs such as those that define a Fifth Generation (5G) new radio (NR) system or a later system. The base station 108 may provide user plane and control plane protocol terminations toward the UE 104.

In some embodiments, the UE 104 and base station 108 may establish data radio bearers (DRBs) to support transmission of data over a wireless link between the two nodes. In one example, these DRBs may be used for traffic from extended reality (XR) applications that contains a large amount of data conveying real and virtual images and audio for presentation to a user.

The network environment 100 may further include a core network 112. For example, the core network 112 may comprise a 5^{th} Generation Core network (5GC) or later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

The network environment 100 may further include an external data network 120. The external data network 120 may include a system of interconnected nodes that facilitate data transmission between UE 104 and various application servers and other service providers. The base station 108 and the core network 112 may route application data between the UE 104 and external data network 120 or application servers. These application servers host web applications, cloud storage, and multimedia streaming services, which communicate with the UE 104 via standardized protocols and interfaces defined by 3GPP, ensuring secure and efficient data exchange.

Operations described herein as performed by a device (for example, UE 104, base station 108, and/or a device of core network 112) may be fully, substantially, or partially performed by processing circuitry implemented on the device. Additionally, operations described herein as performed by “the network” may be performed by a device of the RAN 110 (e.g., base station 108), a device of the core network 112, and/or components thereof.

The core network 112 may include a user plane function (UPF) 116 that provides for routing and forwarding of user plane packets between the base station 108 and an external data network 120. The base station 108 may receive uplink packets from the UE 104 through the DRBs and may transmit the uplink packets to the UPF 116 through a general packet radio service (GPRS) tunneling protocol-user plane (GTP-U) tunnel. The UPF 116 may remove the packet headers and forward the packets to the external data network 120. The UPF 116 may map downlink packets arriving from an external data network onto specific quality of service (QoS) flows belonging to specific PDU sessions before forwarding to the base station 108. The base station 108 may map the traffic to the appropriate DRBs for delivery to the UE 104.

The UE 104 may include an application layer that generates application traffic to be transmitted to another device through the network environment 100. In some embodiments, the application layer may have an XR application that generates XR traffic. However, embodiments are not limited to XR use cases.

For XR and other services, the application layer may generate data packets, which may also be referred to as protocol data units (PDUs). The individual PDUs may be may Internet protocol (IP) packets or non-IP packets. In some instances, the application layer may generate PDU sets, with individual PDU sets comprising one or more PDUs. The packets of a PDU set may carry a payload of one unit of information generated by the application layer. The unit of information may be a frame or video slice for XR Services such as those defined in 3GPP Technical Report (TR) 26.926 v18.2.0 (2024-Mar.-26), for example. In some implementations all PDUs in the PDU Set may be needed by an application layer at a destination node to allow the application layer to recover parts or all of the information unit. In other implementations, the application layer on the destination node may still be able to recover parts or all of the information unit even if some PDUs of a PDU set are missing.

In some embodiments, the data produced by an application layer of the UE 104 may include multi-modal data. Multi-modal data may include input data from different kinds of devices/sensors or the output data to different kinds of destinations (e.g. one or more UEs) desired for the same task or application. Multi-modal data may include more than one single-modal data (e.g., one type of data), and there may be a strong dependency among each single-modal data associated with multi-modal data.

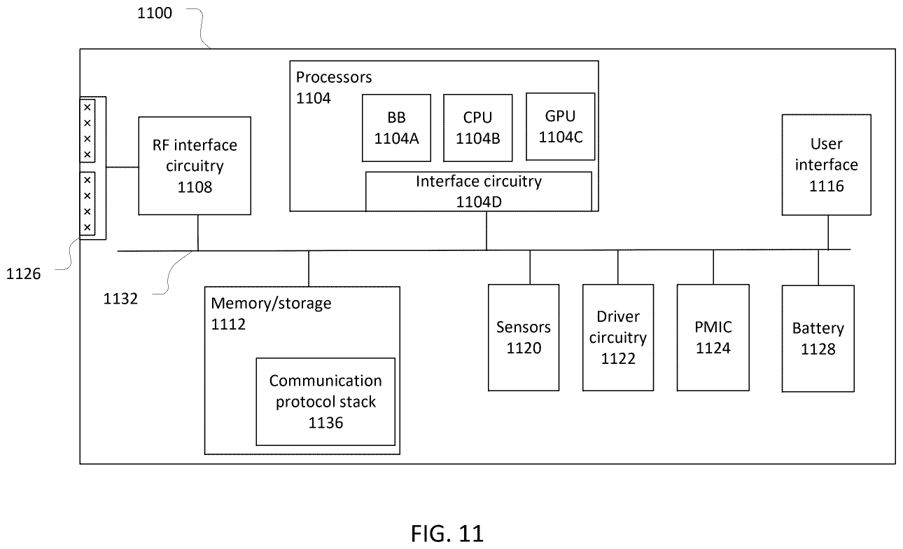

The PDUs may be provided to a transmitter of the UE 104 that is configured to execute a communication protocol stack, for example, communication protocol stack 1136 of FIG. 11, to facilitate communication via the network environment 100. The transmitter may implement layer 2 (L2) and layer 1 (L1) functionality. At the L2 level, the transmitter may include a service data adaptation protocol (SDAP) layer, a packet data convergence protocol (PDCP) layer, a radio link control (RLC) layer, and a media access control (MAC) layer. At the L1 level, the transmitter may include a physical (PHY) layer. Briefly, the SDAP layer may manage QoS flow handling between the QoS flows and the DRBs. The PDCP layer may manage robust header (de)compression and security between DRBs and RLC channels. The RLC layer may manage (re-)segmentation and error correction through automatic repeat request (ARQ) between logical channels and RLC channels. The MAC layer may manage scheduling/priority handling, (de)multiplexing, and hybrid automatic repeat request (HARQ) processes between logical channels and transport channels. And the PHY layer may manage the processing of the physical data and control channels.

A packet received by a layer from higher layers may be called a service data unit (SDU) of that layer. The packet transmitted by the layer to lower layers is called the PDU of that layer. For example, packets received by a PDCP layer from an SDAP layer are called PDCP SDUs, and packets sent by the PDCP layer to an RLC layer are called PDPC PDUs. In this sense, a packet may be referred to as either an SDU or a PDU depending on the layer perspective. Thus, packets of a PDU set may be referred to as SDAP PDUs or PDCP SDUs. Further, an SDAP PDU may include the information of an application layer PDU and, therefore, the PDU set concept may apply to various protocol layers.

Each PDCP SDU may maintain its own discard timer. This is the case even for PDCP SDUs belonging to the same PDU set. PDCP SDUs belonging to the same PDU set do not necessarily arrive at the same time. This may be due to, for example, uplink (UL) jitter in tethered use cases, where packets experience different jitter before reaching the UE. Thus, each PDCP SDU may have different remaining times, even if they belong to the same PDU set. PDU set discarding may be configured when the application layer can only make use of a PDU set when all packets of the PDU Set are received. To make sure data is useful for the application layer, it is beneficial for all packets of the PDU set to be transmitted immediately despite the remaining time of each individual PDCP SDU.

In some instances delay-aware scheduling may be applied to reduce packet discarding. For example, if a network knows that a remaining time until discard timer expiry for a PDU is already quite short, delivery of this PDU may be considered urgent and the network may perform a timely resource allocation to ensure the PDU is timely transmitted. This may reduce the number of packets that need to be discarded, and hence improves user experience.

Delay status reporting (DSR) may include an uplink MAC control element (CE) that enables a UE to report the explicit remaining time until expiration of discard timer (per logical channel group (LCG)) and an associated data volume. If no DSR is triggered for an LCH/LCG, a new DSR may be triggered for the LCH/LCG when a shortest remaining-time left for buffered data in uplink is smaller than a configured remaining time threshold. One or more thresholds may be configured per LCG for DSR triggering purposes. If PDU set discarding is configured, a data volume calculation to be reported in the DSR may consider a size of the full remaining PDUs in the PDU set (if any PDU within the PDU set is associated with a remaining time below the threshold). In some instances, single delay information per LCG may be supported as a baseline for DSR. The remaining time, for example, the shortest remaining time in the LCG, may be explicitly reported in the DSR. It is anticipated that, in Release 19 3GPP TSs, DSR enhancements with multiple remaining time thresholds configured for an LCH/LCG may be introduced, which enables the UE to report more comprehensive information of the buffer delay status.

While such feedback information may allow the network to perform delay-aware scheduling, it may not guarantee that urgent packets can be delivered sooner. For example, the network may choose to skip scheduling if it thinks that the remaining time is already too short. Thus, such information only assists the network to make more judicious decisions in terms of radio resource management.

Release 19 3GPP Technical Specifications (TSs) will require the study of enhancements to delivery of XR data using delay/deadline information to support UL scheduling. This will enable high XR capacity while meeting delay requirements and avoiding excessive delay of delivering PDUs.

Various logical channel prioritization (LCP) enhancements may be based on buffer delay. For example, delay-aware LCP enhancement may be used to resolve an issue of data with a low remaining time being delayed due to data from other LCHs with no delay critical data. As compared to DSR, such enhancements may represent a more proactive mechanism that a UE may apply to minimize UL packet discarding. For delay-aware LCP enhancement, priority of an LCH may be overridden/adjusted based on delay/deadline information. This may be enabled by use of one or more additional priorities configured to an LCH that has, or may have, delay-critical data. If priority of an LCH is adjusted, the adjusted priority may apply to all data within the LCH, or may apply only to the delay-critical data within the LCH. The delay-aware LCP mechanism may be configured in a semi-static way. No dynamic indications may be needed for triggering these delay-aware LCP mechanisms. In some instances, use of delay-aware LCP mechanisms may not prevent non-delay critical data from using an UL grant. Data that is considered delay-critical for purposes of the delay-aware LCP mechanisms may be based on a remaining time threshold used for DSR or it could be a separate remaining time threshold.

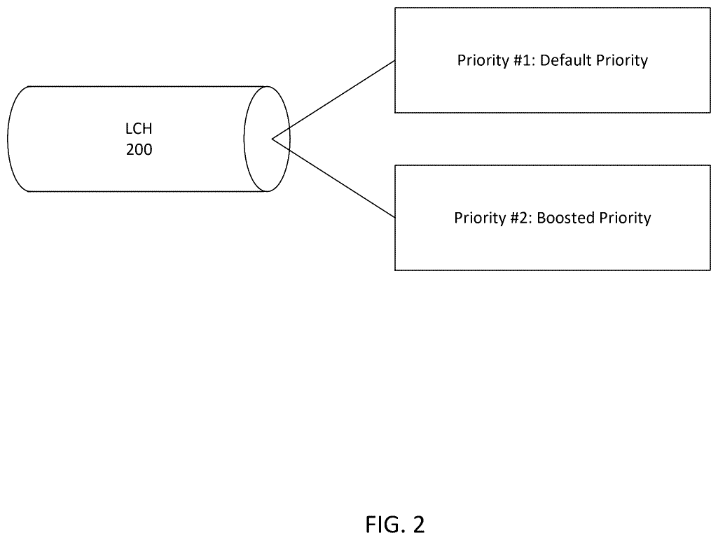

In various embodiments, a LCH may be configured with multiple LCH priorities. For example, FIG. 2 shows an LCH 200 that is configured with two LCH priorities in accordance with some embodiments. In some embodiments, a network may provide the UE 104 with configuration information via RRC signaling, for example, to semi-statically configure the priorities for the LCH. Generic reference to “network,” as used herein, may refer to one or more components of the RAN 110 or the core network 112.

In some embodiments, the configured priorities may include a default LCH priority level (referred to as “Priority #1 in FIG. 2) and a boosted LCH priority level (referred to as Priority #2). The LCH 200 may be associated with the default priority in a default state, e.g., when all packets in a buffer of the LCH 200 have a remaining time to discard (for example, remaining time until expiry of respective discard timers) larger than a threshold. The UE 104 may switch the priority level of the LCH 200 to the boosted LCH priority level based on a first condition. The first condition may include, for example, that the remaining time of at least one packet in the buffer of the LCH 200 is smaller than the threshold. Such LCH priority adaptation can happen even before an uplink (UL) grant is received. This may avoid dynamic adaptation during LCP procedure that may increase complexity. When the first condition is no longer met (e.g., there are no more packets with remaining time smaller than the threshold in the buffer of the LCH 200), the UE 104 may switch the priority back to the default value.

In some embodiments, the priority adjustment of a first LCH may further depend on a second condition associated with one or more other LCHs of the UE 104 (e.g., at the same protocol layer). For example, the second condition may include whether a volume of delay-critical data in a buffer of at least one other LCH is greater than a corresponding threshold; whether a volume of important data (e.g., with at least a threshold importance level) in the buffer of at least one other LCH is greater than a corresponding threshold; whether a volume of delay-critical data and important data in the buffer of at least one other LCH is greater than a corresponding threshold; or whether a bit rate metric (e.g., Bj value) of at least one other LCH is greater than a corresponding threshold. In other embodiments, the second condition may include that a metric of another LCH is worse than a corresponding metric of the LCH 200. The metric may include, for example, a volume of delay-critical data, a volume of important data, a volume of delay-critical data and important data, or a bit rate metric (e.g., Bj).

In some embodiments, if the second condition is not met, the UE 104 may adjust the priority level of the LCH 200 to a first boosted priority level (e.g., the boosted priority that was configured for the LCH 200 via RRC signaling). If the second condition is met, the UE 104 may adjust the priority level of the LCH 200 to a second boosted priority level. The second boosted priority may be configured for the LCH 200 (e.g., via RRC signaling), may be predefined, or may be determined based on the default priority and/or first boosted priority of the LCH 200 and/or the other LCH (e.g., in accordance with an offset).

In some embodiments, the second boosted priority level may be higher priority than the default priority and lower priority than the first boosted priority. Accordingly, the LCH priority adjustment to the second boosted priority may enable the priority of the LCH 200 to be boosted based on the first condition while also accounting for the status of the other LCHs (e.g., based on the second condition).

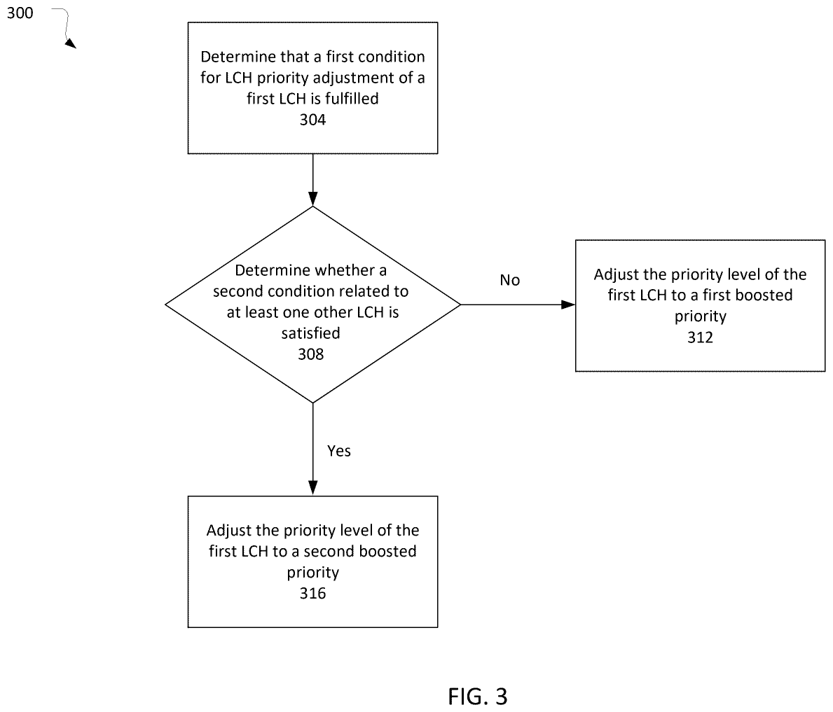

FIG. 3 illustrates a procedure 300 in accordance with some embodiments. In embodiments, the procedure 300 may be performed by a UE (e.g., UE 104) or components thereof.

At 304, the procedure 300 may include to determine that a first condition for LCH priority adjustment of a first LCH is fulfilled. The first condition may include, for example, that a remaining time to discard of at least one packet in a buffer associated with the first LCH is less than a remaining time threshold. The remaining time threshold may be pre-defined and/or configured by the network. The first LCH (which may also be referred to as the target LCH) may be configured with a default priority and at least one boosted priority.

In some embodiments, the remaining time threshold may be provided by an RRC parameter remainingTimeThreshold as defined by 3GPP TS 38.331 v18.2.0 (Jul. 11, 2024), which was introduced for DSR, for example. In other embodiments, the remaining time threshold is a new RRC parameter that is different from the remainingTimeThreshold defined in 3GPP TS 38.331. In still other embodiments, the remaining time threshold may be statically defined such that it does not need to be configured by RRC signaling. In some embodiments, if multiple remaining time threshold levels for the corresponding LCG/LCH are configured for DSR (as anticipated in Rel-19), the network may indicate one of these multiple remaining time threshold levels per LCH/LCG configured for DSR as the remaining time threshold to determine whether various delay-related conditions are met for operations relating to LCP as described herein (e.g., the operation 304 and/or other delay-related conditions described herein). Alternatively, the UE may apply the highest or the lowest remaining time threshold level per LCH/LCG configured for DSR as the remaining time threshold to determine whether various delay-related conditions are met for operations described herein (e.g., when the network indication for threshold selection is absent).

At 308, the procedure 300 may include to determine whether a second condition related to at least one other LCH (e.g., referred to as a second LCH) is satisfied. In some embodiments, the second condition may include whether the volume of delay-critical data in a buffer associated with the second LCH exceeds a volume threshold. Delay-critical data may refer to data with an associated remaining time that is less than the remaining time threshold. In some embodiments, the volume threshold may be zero (e.g., the condition is satisfied if there is at least one delay-critical packet in the buffer of the second LCH). In other embodiments, the volume threshold may be an integer greater than zero (e.g., 100 Bytes, 200 Bytes, etc.).

In some embodiments, the second condition may include whether a volume of important data in the buffer of the second LCH is greater than an importance volume threshold. Important data may refer to data packets with an importance level that is at least a threshold level. In some embodiments, the importance volume threshold may be zero (e.g., the condition is satisfied if there is at least one important packet in the buffer of the second LCH). In other embodiments, the importance volume threshold may be an integer greater than zero (e.g., 100 Bytes, 200 Bytes, etc.).

In some embodiments, the second condition may include whether a total volume of delay-critical and important data in the buffer of the second LCH is greater than a corresponding threshold (which may be zero or a positive integer).

In some embodiments, the second condition may include whether a current or latest bit rate metric, Bj, satisfies a bit rate threshold. The bit rate metric, Bj, may be a variable that is maintained by the respective LCHs, e.g., for a logical channel prioritization procedure. The value of Bj may be incremented by the product of a prioritized bit rate (prioritizedBitRate) and a time period, T. The time period, T, may be the time period since the value of Bj was previously updated. The result from this multiplication represents the volume of data which the logical channel is required to transfer to achieve its prioritized bit rate. The Bj value may be as defined by 3GPP TS 38.321, V18.2.0, Section 5.4.3.1 (Jul. 12, 2024), for example.

In some embodiments, the second condition may be considered to be satisfied if any of multiple sub-conditions (e.g., the conditions described above) are satisfied.

In current systems, the UE may support up to 20 LCHs at one time. The second condition may be considered to be satisfied if at least one of the LCHs apart from the first LCH (also referred to as the target LCH) meets the second condition.

If it is determined at 308 that the second condition is not satisfied then, at 312, the procedure 300 may include to adjust the priority level of the first LCH to a first boosted priority (e.g., from the default priority). The first boosted priority may be configured for the first LCH, e.g., via RRC signaling. The first boosted priority may be greater than the default priority. Accordingly, the first boosted priority may enable the delay-critical data in the first LCH to be transmitted more quickly than with the default priority.

If it is determined at 308 that the second condition is satisfied then, at 316, the procedure 300 may include to adjust the priority level of the first LCH to a second boosted priority (e.g., from the default priority). The second boosted priority may be greater than the default priority and less than the first boosted priority.

In some embodiments, the second boosted priority may be configured by the network in addition to the first boosted priority. Alternatively, the second boosted priority may not be explicitly configured for the UE. For example, in some embodiments the second boosted priority may be a fixed value in the 3GPP technical specification. In other embodiments, the second boosted priority may be an offset (X) from the default priority (e.g., the default priority plus or minus X) or the first boosted priority (e.g., the first boosted priority plus or minus X) of the first LCH. The offset may be an integer value. In some embodiments, the offset may be predefined or configured by the network. It may be possible for the offset to be zero (e.g., the second boosted priority is equal to the default priority).

In other embodiments, the second boosted priority may be an offset (Y) from the priority (e.g., the default priority, the boosted priority, and/or the active priority) of the second LCH. For example, the second boosted priority may be the priority of the second LCH plus or minus Y. As with the offset above, the offset may be an integer value and the offset may be zero in some instances/configurations (e.g., the second boosted priority is the same as the priority of the second LCH). Thus, the priority of the first LCH may be capped to the priority of the second LCH, when the second condition is satisfied, in order to reduce the impact to the second LCH when the priority of the first LCH is adjusted.

In some embodiments, the evaluation of the second condition at 308 may include a comparison of the second LCH to the first LCH. For example, the second condition may be satisfied if at least one other LCH has a volume of delay-critical data, a volume of important data, a total volume of delay-critical data and important data, and/or a bit rate metric (Bj) that is greater than the corresponding value for the first LCH.

In some embodiments, techniques described herein (e.g., the procedure 300) may be used to adjust one or more other parameters of the first LCH in addition to or instead of the priority level. For example, the prioritized bit rate (PBR), bucket size duration (BSD), and/or Bj value of the first LCH may be adjusted based on the status of the first and/or second LCH as described herein. In some embodiments, the adjusted values for one or more of these parameters may be predefined or configured for the UE.

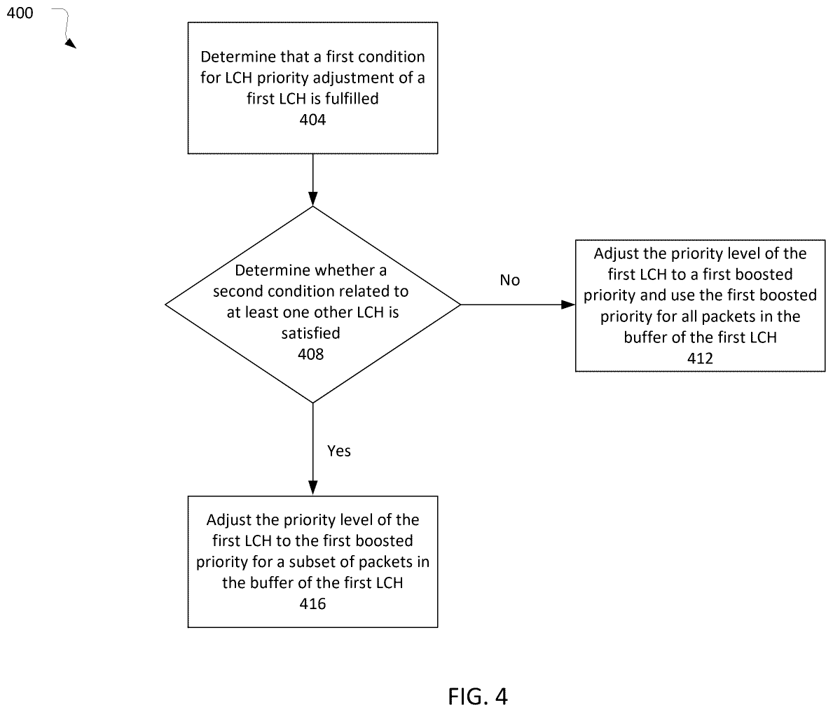

FIG. 4 illustrates another example procedure 400 in accordance with some embodiments. The procedure 400 may be performed by a UE (e.g., UE 104) or components thereof.

Operations 404 and 408 may be similar to operations 304 and 308, respectively, of procedure 300. For example, at 404, the procedure 400 may include to determine whether a first condition for LCH priority adjustment of a first LCH is fulfilled.

The first condition may include, for example, that a remaining time to discard of at least one packet in a buffer associated with the first LCH is less than a remaining time threshold. The remaining threshold may be pre-defined and/or configured by the network (e.g., as described above with respect to FIG. 3). The first LCH (which may also be referred to as the target LCH) may be configured with a default priority and at least one boosted priority.

At 408, the procedure 400 may include to determine whether a second condition related to at least one other LCH (e.g., referred to as a second LCH) is satisfied. The second condition may be as described above with respect to FIG. 3.

If the second condition is not satisfied at 408 then, at 412, the procedure 400 may include to adjust the priority of the first LCH to the boosted priority and use the boosted priority for all packets in the buffer of the first LCH.

If the second condition is satisfied at 408 then, at 416, the procedure 400 may include to adjust the priority of the first LCH to the boosted priority and use the boosted priority for a subset of packets in the buffer of the first LCH. The subset may include the packets in the buffer that are delay-critical (e.g., have an associated remaining time that is less than a threshold). The default priority may continue to be used for the other packets in the buffer that are not included in the subset.

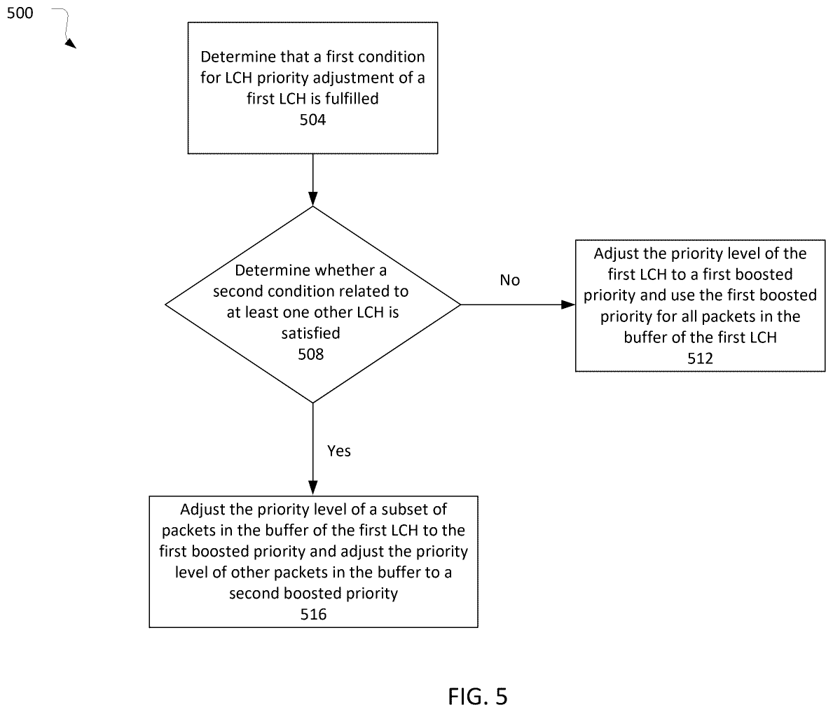

FIG. 5 illustrates another example procedure 500 in accordance with some embodiments. The procedure 500 may be performed by a UE (e.g., UE 104) or components thereof.

Operations 504 and 508 of procedure 500 may be similar to operations 304 and 308, respectively, of procedure 300. For example, at 504, the procedure 500 may include to determine whether a first condition for LCH priority adjustment of a first LCH is fulfilled. The first condition may include, for example, that a remaining time of at least one packet in a buffer associated with the first LCH is less than a remaining time threshold. The remaining time threshold may be pre-defined and/or configured by the network (e.g., as described above with respect to FIG. 3). The first LCH (which may also be referred to as the target LCH) may be configured with a default priority and at least one boosted priority (e.g., including at least a first boosted priority).

At 508, the procedure 500 may include to determine whether a second condition related to at least one other LCH (e.g., referred to as a second LCH) is satisfied. The second condition may be as described above with respect to FIG. 3.

If the second condition is not satisfied at 508 then, at 512, the procedure 400 may include to adjust the priority of the first LCH to the first boosted priority and use the first boosted priority for all packets in the buffer of the first LCH.

If the second condition is satisfied at 508 then, at 516, the procedure 500 may include to adjust the priority of the first LCH to the first boosted priority and use the first boosted priority for a subset of packets in the buffer of the first LCH. The subset may include the packets in the buffer that are delay-critical (e.g., have an associated remaining time that is less than a threshold). A second boosted priority may be used for the other packets in the buffer that are not included in the subset. The second boosted priority may be similar to the second boosted priority of FIG. 3. For example, the second boosted priority may be greater than the default priority and less than the first boosted priority in some instances.

In another aspect of the present disclosure, the UE may identify a subset of other LCHs to consider when determining whether to adjust the priority of the first LCH. For example, the UE may perform the evaluation of the second condition at 308, 408, or 508 of procedures 300, 400, or 500, respectively, for the identified subset of LCHs. The subset of LCHs may include less than all of the LCHs of the UE apart from the first LCH.

The UE may determine which LCHs to include in the subset based on one or more factors. For example, the subset of LCHs may be identified based on: LCHs that are included in a pre-configured list (e.g., configured as part of a configuration of the first LCH and/or a configuration of a MAC entity); LCHs with a default or boosted priority that is higher than the first LCH; LCHs with a default or adjusted priority of at least a threshold level; LCHs with a greater current Bj value than the first LCH; LCHs with a current Bj value of at least a threshold value; LCHs that have been configured with one or more boosted priorities; and/or LCHs that with corresponding DRBs that have activated PDU set importance (PSI)-based discarding (e.g., using different discard timers for packets with different importance).

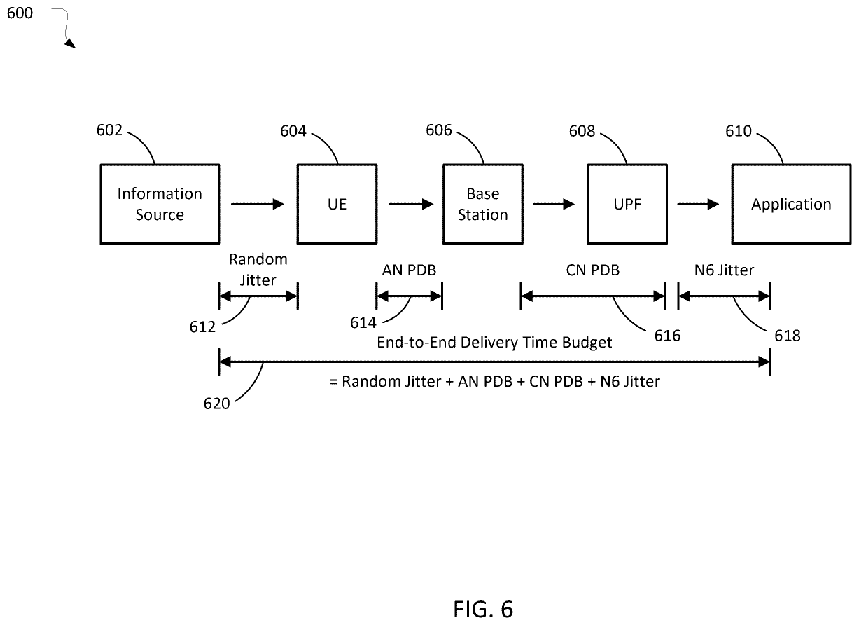

In another aspect of the present disclosure, the UE may boost a priority of a LCH and/or individual packets based on a jitter experienced by one or more packets prior to arriving in the buffer of the LCH. For example, FIG. 6 illustrates an example data flow 600 and associated delays that may occur for packet transmissions from an information source to an information destination via a 3GPP network, in accordance with some embodiments.

The data flow 600 includes an information source 602, a UE 604, a base station 606, a UPF 608, and an application 610. The application 610 may be the information destination in the illustrated example. In some embodiments, the application 610 may be associated with an external data network, such as external data network 120 of FIG. 1.

The information source 602 may have a connection with the UE 604. In some embodiments, the connection between the information source 602 and the UE 604 may be a wireless connection. The information source 602 may be referred to as a tethered device to the UE 604 based on the information source 602 having the connection with the UE 504. The information source 602 may capture information and generate packets of data for transmission to the application 610. For example, in some embodiments, the information source 602 may correspond to a XR headset or other peripheral accessory.

As the information source 602 does not have a direct connection to the application 610, the information source 602 may transmit the packets of data to the UE 604 for forwarding to the application 610. Each of the packets transmitted from the information source 602 to the UE 604 may experience random jitter 512 (e.g., random amounts of delay). For example, the random jitter 612 may be caused by air interface delay in a non-3GPP link with the information source 602 and/or application processing delay (e.g., encoding delay) that may occur at an output of the information source 602, both of which may be random.

The UE 604 may receive the packets from the information source 602. The UE 604 may forward the received packets to the base station 606 for forwarding to the application 610. The UE 604 may store the packets in a buffer associated with a respective LCH while awaiting transmission to the base station 606. Each of the packets transmitted from the UE 604 to the base station 606 may have a AN PDB 614.

The base station 606 may receive the packets from the UE 604. The base station 606 may forward the received packets to the UPF 608. Each of the packets transmitted from the base station 606 to the UPF 608 may have a CN PDB 616.

The UPF 608 may receive the packets from the base station 606. The UPF 608 may forward the received packets to the application 610. Each of the packets transmitted from the UPF 608 to the application may experience N6 jitter 618 (e.g., amounts of delay) when transferred via an N6 interface to application 610.

An end-to-end delivery time budget 620 may be defined for transmission of packets from the information source 602 to application 610. The end-to-end delivery time budget 620 may be defined to include the random jitter 612, the AN PDB 614, the CN PDB 616, and the N6 jitter 618. The end-to-end delivery time budget 620 may define a maximum time for packets of data to be transmitted from information source 602 to the application 610, where packets that take longer than the end-to-end delivery time budget 620 to be delivered from the information source 602 to the application 610 may be treated as expired or outdated.

In embodiments herein, the UE 604 may adjust a priority of a packet or the associated LCH based on the jitter experienced by the packet prior to receipt of the packet by the UE 604 (e.g., the random jitter 612). For example, the UE 604 may use a higher priority (e.g., the boosted priority described herein) for the packet or the associated LCH based on a determination that the packet experienced a random jitter 612 of greater than a threshold amount (which may be zero or a non-zero value). Accordingly, packets that experience random jitter 612 may be transmitted more quickly, thereby enabling the packets to meet the end-to-end delivery time budget 620.

The UE 604 may determine the jitter experienced by the packet prior to receipt of the packet by the UE 604 using one or more techniques. For example, the delay may be evaluated based on expected/theoretical arrival time information provided by the application layer, the tethered device, and/or a core network function. In another example, the delay may be evaluated based on a time stamp provided from the tethered device (e.g., indication of when the packet was first generated/transmitted by the tethered device). In another example, the delay may be evaluated based on the generalized precision time protocol (G-PTP).

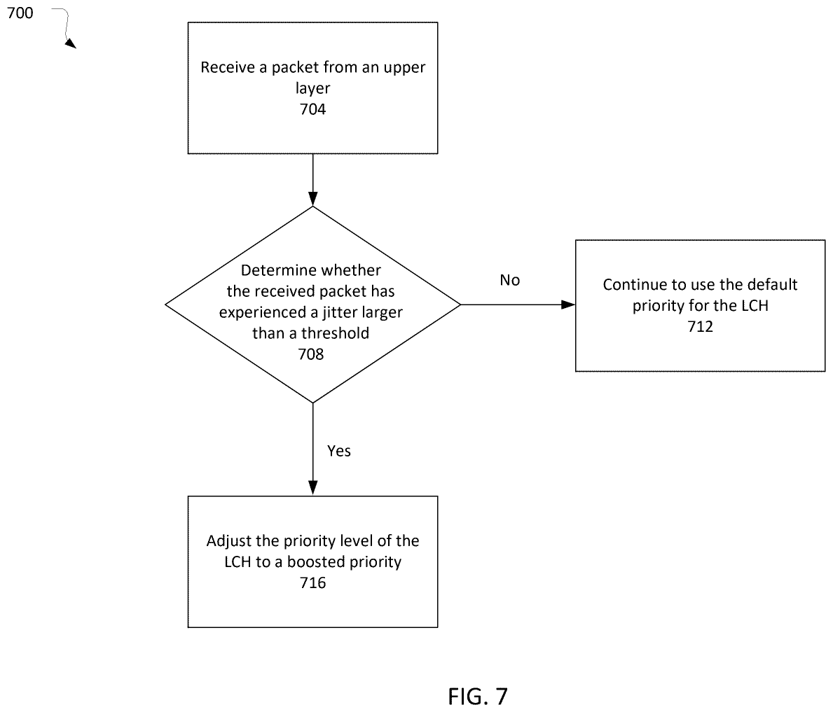

FIG. 7 illustrates an example procedure 700 in accordance with some embodiments. The procedure 700 may be performed by a UE (e.g., UE 104) or components thereof.

At 704, the procedure 700 may include to receive a packet from an upper layer. The UE may store the received packet in a buffer associated with a LCH for transmission.

At 708, the procedure 700 may include to determine whether the received packet has experienced jitter larger than a threshold. The jitter may have occurred in an external device/accessory, such as a XR headset. In some embodiments, the jitter threshold may be configured by the network. The jitter threshold may be a non-zero value or zero in some instances (e.g., indicating that the condition at 708 is satisfied if the packet experienced any jitter).

If it is determined that the packet has not experienced jitter larger than the threshold, then, at 712, the procedure 700 may include to continue use the default priority for the LCH.

If it is determined that the packet has experienced jitter larger than the threshold then, at 716, the procedure 700 may include to adjust the priority of the LCH (and/or the individual packet) to a boosted priority. In other embodiments, one or more other parameters of the LCH may be adjusted at 716 in addition to or instead of the priority level. For example, the one or more other parameters may include the PBR and/or one or more LCH mapping restriction rules.

In some embodiments, the evaluation of the condition at 708 may be based on more than one received packet. For example, the condition may be satisfied if a total number of packets and/or data volume of packets in the buffer that have experienced jitter larger than a jitter threshold is greater than a corresponding threshold.

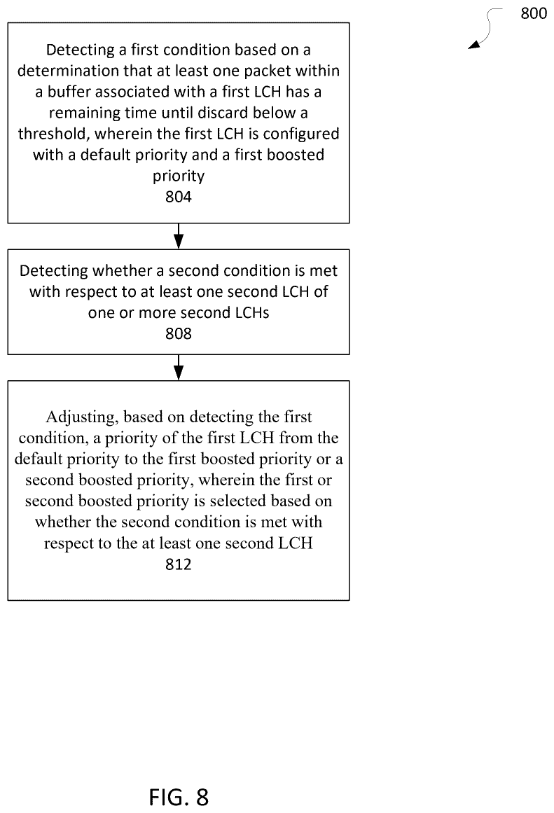

FIG. 8 illustrates an operation flow/algorithmic structure 800 in accordance with some embodiments. The operation flow/algorithmic structure 800 may be performed by a UE, such as UE 104, UE 1100, or components therein, for example, baseband processor 1104A.

The operation flow/algorithmic structure 800 may include, at 804, detecting a first condition based on a determination that at least one packet within a buffer associated with a first LCH has a remaining time until discard below a threshold, wherein the first LCH is configured with a default priority and a first boosted priority.

The operation flow/algorithmic structure 800 may further include, at 808, detecting whether a second condition is met with respect to at least one second LCH of one or more second LCHs. In some embodiments, the second condition may include whether a volume of delay-critical data in a second buffer associated with the at least one second LCH is greater than a second threshold; whether a volume of important data in the second buffer with at least a threshold importance level is greater than a third threshold; whether a volume of delay-critical data and important data in the second buffer is greater than a fourth threshold; or wherein a bit rate metric of the second LCH is greater than a fifth threshold. In other embodiments, the second condition may include that a metric of the at least one second LCH is worse than a corresponding metric of the first LCH. The metric may include, for example, a volume of delay-critical data, a volume of important data with at least a threshold importance level, a volume of delay-critical data and important data, or a bit rate metric (e.g., Bj).

The operation flow/algorithmic structure 800 may further include, at 812, adjusting, based on detecting the first condition, a priority of the first LCH from the default priority to the first boosted priority or a second boosted priority, wherein the first or second boosted priority is selected based on whether the second condition is met with respect to the at least one second LCH. In some embodiments, the second boosted priority may be less than the first boosted priority and/or greater than the default priority. The second boosted priority may be, for example, configured for the first LCH, a predetermined value, determined based on a first offset with reference to the default priority or the first boosted priority, and/or determined based on a second offset with reference to a priority of the at least one second LCH.

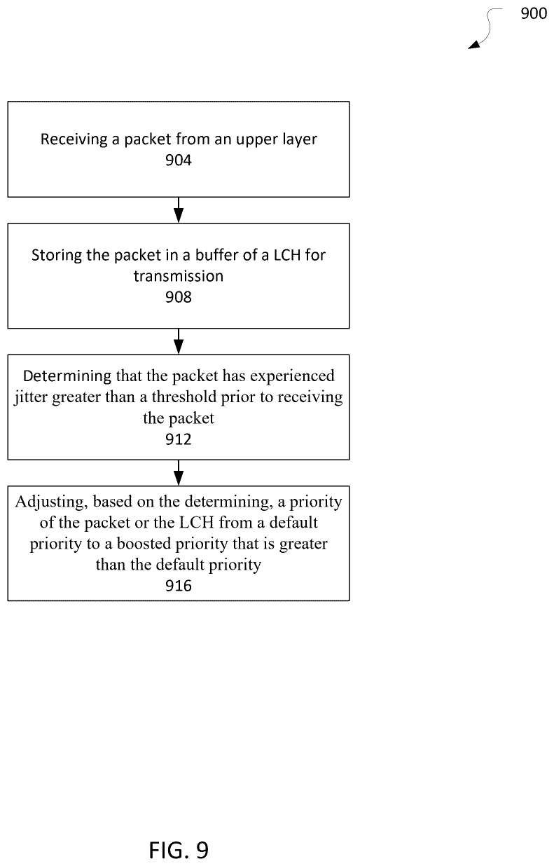

FIG. 9 illustrates another operation flow/algorithmic structure 900 in accordance with some embodiments. The operation flow/algorithmic structure 900 may be performed by a UE, such as UE 104, UE 1100, or components therein, for example, baseband processor 1104A.

The operation flow/algorithmic structure 900 may include, at 904, receiving a packet from an upper layer.

The operation flow/algorithmic structure 900 may further include, at 908, storing the packet in a buffer of a LCH for transmission.

The operation flow/algorithmic structure 900 may further include, at 912, determining that the packet has experienced jitter greater than a threshold prior to receiving the packet. The jitter may have occurred in an external device/accessory, such as a XR headset. In some embodiments, the jitter threshold may be configured by the network. The jitter threshold may be a non-zero value or zero in some instances.

The operation flow/algorithmic structure 900 may further include, at 916, adjusting, based on the determining, a priority of the packet or the LCH from a default priority to a boosted priority that is greater than the default priority.

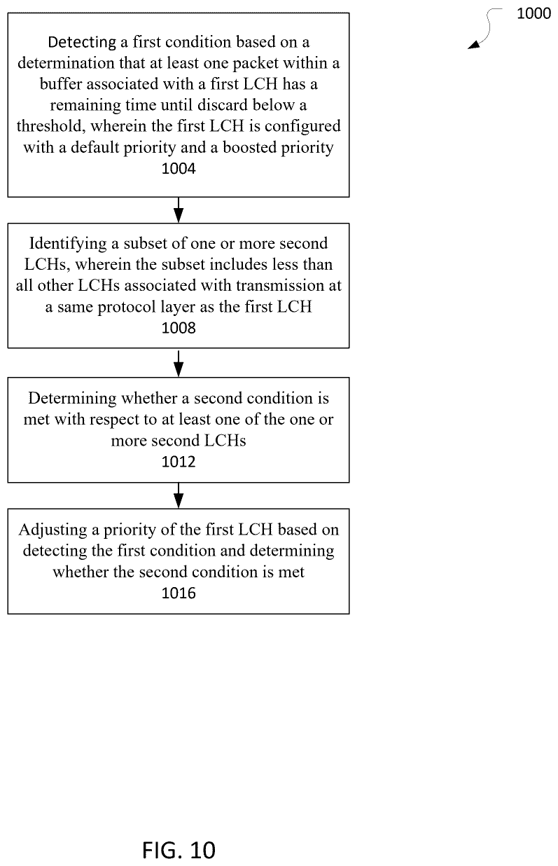

FIG. 10 illustrates another operation flow/algorithmic structure 1000 in accordance with some embodiments. The operation flow/algorithmic structure 1000 may be performed by a UE, such as UE 104, UE 1100, or components therein, for example, baseband processor 1104A.

The operation flow/algorithmic structure 1000 may include, at 1004, detecting a first condition based on a determination that at least one packet within a buffer associated with a first LCH has a remaining time until discard below a threshold, wherein the first LCH is configured with a default priority and a boosted priority.

The operation flow/algorithmic structure 1000 may further include, at 1008, identifying a subset of one or more second LCHs, wherein the subset includes less than all other LCHs associated with transmission at a same protocol layer as the first LCH.

The operation flow/algorithmic structure 1000 may further include, at 1012, determining whether a second condition is met with respect to at least one of the one or more second LCHs.

The operation flow/algorithmic structure 1000 may further include, at 1016, adjusting a priority of the first LCH based on detecting the first condition and determining whether the second condition is met.

FIG. 11 illustrates a UE 1100 in accordance with some embodiments. The UE 1100 may be similar to and substantially interchangeable with UE 104.

The UE 1100 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 1100 may include processors 1104, RF interface circuitry 1108, memory/storage 1112, user interface 1116, sensors 1120, driver circuitry 1122, power management integrated circuit (PMIC) 1124, antenna 1126, and battery 1128. The components of the UE 1100 may be implemented as integrated circuits (ICs), portions thereof, discrete electronic devices, or other modules, logic, hardware, software, firmware, or a combination thereof. In some embodiments, the RF interface circuitry 1108 may be included in the processors 1104. The block diagram of FIG. 11 is intended to show a high-level view of some of the components of the UE 1100. However, some of the components shown may be omitted, additional components may be present, and different arrangement of the components shown may occur in other implementations.

The components of the UE 1100 may be coupled with various other components over one or more interconnects 1132, which may represent any type of interface, input/output, bus (local, system, or expansion), transmission line, trace, or optical connection that allows various circuit components (on common or different chips or chipsets) to interact with one another.

The processors 1104 may include processor circuitry such as, for example, baseband processor circuitry (BB) 1104A, central processor unit circuitry (CPU) 1104B, and graphics processor unit circuitry (GPU) 1104C. The processors 1104 may include any type of circuitry or processor circuitry that executes or otherwise operates computer-executable instructions, such as program code, software modules, or functional processes from memory/storage 1112 to cause the UE 1100 to perform LCH priority transitions as described herein. The processors 1104 may also include interface circuitry 1104D to enable communication by, for example, communicatively coupling the processor circuitry with one or more other components of the UE 1100.

In some embodiments, the baseband processor 1104A may access a communication protocol stack 1136 in the memory/storage 1112 to communicate over a 3GPP compatible network. In general, the baseband processor 1104A may access the communication protocol stack 1136 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1108.

The baseband processor 1104A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1112 may include one or more non-transitory, computer-readable media that includes instructions (for example, communication protocol stack 1136) that may be executed by one or more of the processors 1104 to cause the UE 1100 to perform LCH priority transitions as described herein.

The memory/storage 1112 includes any type of volatile or non-volatile memory that may be distributed throughout the UE 1100. In some embodiments, some of the memory/storage 1112 may be located on the processors 1104 themselves (for example, memory/storage 1112 may be part of a chipset that corresponds to the baseband processor 1104A), while other memory/storage 1112 is external to the processors 1104 but accessible thereto via a memory interface. The memory/storage 1112 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1108 may include transceiver circuitry and a radio frequency front module (RFEM) that allows the UE 1100 to communicate with other devices over a radio access network. The RF interface circuitry 1108 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1126 and proceed to filter and amplify (with a low-noise amplifier) the signal. The signal may be provided to a receiver of the transceiver that down-converts the RF signal into a baseband signal that is provided to the baseband processor of the processors 1104.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1126.

In various embodiments, the RF interface circuitry 1108 may be configured to transmit/receive signals in a manner compatible with NR access technologies.

The antenna 1126 may include antenna elements to convert electrical signals into radio waves to travel through the air and to convert received radio waves into electrical signals. The antenna elements may be arranged into one or more antenna panels. The antenna 1126 may have antenna panels that are omnidirectional, directional, or a combination thereof to enable beamforming and multiple input, multiple output communications. The antenna 1126 may include microstrip antennas, printed antennas fabricated on the surface of one or more printed circuit boards, patch antennas, or phased array antennas. The antenna 1126 may have one or more panels designed for specific frequency bands including bands in FR1 or FR2.

The user interface 1116 includes various input/output (I/O) devices designed to enable user interaction with the UE 1100. The user interface 1116 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1100.

The sensors 1120 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1122 may include software and hardware elements that operate to control particular devices that are embedded in the UE 1100, attached to the UE 1100, or otherwise communicatively coupled with the UE 1100. The driver circuitry 1122 may include individual drivers allowing other components to interact with or control various input/output (I/O) devices that may be present within, or connected to, the UE 1100. For example, driver circuitry 1122 may include a display driver to control and allow access to a display device, a touchscreen driver to control and allow access to a touchscreen interface, sensor drivers to obtain sensor readings of sensors 1120 and control and allow access to sensors 1120, drivers to obtain actuator positions of electro-mechanic components or control and allow access to the electro-mechanic components, a camera driver to control and allow access to an embedded image capture device, audio drivers to control and allow access to one or more audio devices.

The PMIC 1124 may manage power provided to various components of the UE 1100. In particular, with respect to the processors 1104, the PMIC 1124 may control power-source selection, voltage scaling, battery charging, or DC-to-DC conversion.

A battery 1128 may power the UE 1100, although in some examples the UE 1100 may be mounted deployed in a fixed location and may have a power supply coupled to an electrical grid. The battery 1128 may be a lithium ion battery, a metal-air battery, such as a zinc-air battery, an aluminum-air battery, a lithium-air battery, and the like. In some implementations, such as in vehicle-based applications, the battery 1128 may be a typical lead-acid automotive battery.

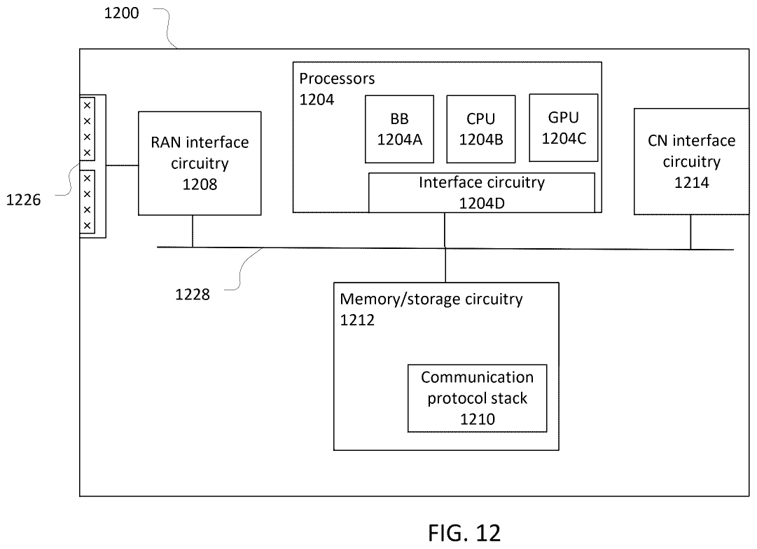

FIG. 12 illustrates a network device 1200 in accordance with some embodiments. The network device 1200 may be similar to, and substantially interchangeable with, the base station 108.

The network device 1200 may include processors 1204, RF interface circuitry 1208 (if implemented as a base station), core network (CN) interface circuitry 1214, memory/storage circuitry 1212, and antenna structure 1226.

The components of the network device 1200 may be coupled with various other components over one or more interconnects 1228.

The processors 1204, RF interface circuitry 1208, memory/storage circuitry 1212 (including communication protocol stack 1210), antenna structure 1226, and interconnects 1228 may be similar to like-named elements shown and described with respect to FIG. 11.

The processors 1204 may include processor circuitry such as, for example, baseband processor circuitry (BB) 1204A, central processor unit circuitry (CPU) 1204B, and graphics processor unit circuitry (GPU) 1204C. The processors 1204 may include any type of circuitry or processor circuitry that executes or otherwise operates computer-executable instructions, such as program code, software modules, or functional processes from memory/storage circuitry 1212 to cause the network device 1200 to configure a UE as described herein. The processors 1204 may also include interface circuitry 1204D to communicatively couple the processor circuitry with one or more other components of the network device 1200.

The CN interface circuitry 1214 may provide connectivity to a core network, for example, a 5^{th} Generation Core network (5GC) using a 5GC-compatible network interface protocol such as carrier Ethernet protocols, or some other suitable protocol. Network connectivity may be provided to/from the network device 1200 via a fiber optic or wireless backhaul. The CN interface circuitry 1214 may include one or more dedicated processors or FPGAs to communicate using one or more of the aforementioned protocols. In some implementations, the CN interface circuitry 1214 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method comprising: detecting a first condition based on a determination that at least one packet within a buffer associated with a first logical channel (LCH) has a remaining time until discard below a threshold, wherein the first LCH is configured with a default priority and a first boosted priority; detecting whether a second condition is met with respect to at least one second LCH of one or more second LCHs; and adjusting, based on detecting the first condition, a priority of the first LCH from the default priority to the first boosted priority or a second boosted priority, wherein the first or second boosted priority is selected based on whether the second condition is met with respect to the at least one second LCH.

Example 2 includes the method of example 1 or some other example herein, wherein adjusting the priority of the first LCH includes adjusting the priority of the first LCH to the second boosted priority based on detecting that the second condition is met for the at least one second LCH, wherein the second boosted priority is lower than the first boosted priority.

Example 3 includes the method of example 1 or some other example herein, wherein the buffer is a first buffer, wherein the threshold is a first threshold, and wherein the second condition includes: whether a volume of delay-critical data in a second buffer associated with the at least one second LCH is greater than a second threshold; whether a volume of important data in the second buffer with at least a threshold importance level is greater than a third threshold; whether a volume of delay-critical data and important data in the second buffer is greater than a fourth threshold; or wherein a bit rate metric of the second LCH is greater than a fifth threshold.

Example 4 includes the method of example 1 or some other example herein, wherein the second condition includes that a metric of the at least one second LCH is higher or lower than a corresponding metric of the first LCH.

Example 5 includes the method of example 4 or some other example herein, wherein the metric includes a volume of delay-critical data, a volume of important data with at least a threshold importance level, a volume of delay-critical data and important data, or a bit rate metric.

Example 6 includes the method of example 1 or some other example herein, further comprising adjusting one or more other parameters of the first LCH based on detecting the first condition and detecting whether the second condition is met, wherein the one or more other parameters include a prioritized bit rate (PBR) or a bucket size duration (BSD).

Example 7 includes the method of example 1 or some other example herein, wherein the adjusted priority applies to a subset of packets in the buffer.

Example 8 includes the method of example 1 or some other example herein, wherein the second boosted priority is: configured for the first LCH; a predetermined value; determined based on a first offset with reference to the default priority or the first boosted priority; or determined based on a second offset with reference to a priority of the at least one second LCH.

Example 9 includes the method of example 1 or some other example herein, wherein the one or more second LCHs is a subset of LCHs other than the first LCH, wherein the subset of LCHs includes the one or more LCHs that: are included in a pre-configured list; have a default or adjusted priority that is greater than the respective default priority or first boosted priority of the first LCH; have a default or adjusted priority of at least a threshold level; have a bit rate metric that is greater than a bit rate metric of the first LCH; have a bit rate metric of at least a threshold value; have a configured boosted priority; or are associated with data radio bearers that have activated protocol data unit (PDU) set importance (PSI)-based discarding.

Example 10 includes a method comprising: receiving a packet from an upper layer; storing the packet in a buffer of a logical channel (LCH) for transmission; determining that the packet has experienced jitter greater than a threshold prior to receiving the packet; and adjusting, based on the determining, a priority of the packet or the LCH from a default priority to a boosted priority that is greater than the default priority.

Example 11 includes the method of example 10 or some other example herein, further comprising receiving a configuration of the boosted priority.

Example 12 includes the method of example 10 or some other example herein, wherein adjusting the priority includes adjusting the priority for all packets in the LCH.

Example 13 includes the method of example 10 or some other example herein, wherein adjusting the priority includes adjusting the priority includes adjusting the priority for the packet while maintaining the default priority for one or more other packets stored in the buffer.

Example 14 includes the method of example 10 or some other example herein, wherein the buffer is a first buffer, the LCH is a first LCH, and wherein adjusting the priority is based further on whether there is delay-critical data in a second buffer of a second LCH, wherein the delay-critical data includes data that has experienced jitter greater than the threshold or that has a remaining time less than a remaining time threshold.

Example 15 includes a method comprising: detecting a first condition based on a determination that at least one packet within a buffer associated with a first logical channel (LCH) has a remaining time until discard below a threshold, wherein the first LCH is configured with a default priority and a boosted priority; identifying a subset of one or more second LCHs, wherein the subset includes less than all other LCHs associated with transmission at a same protocol layer as the first LCH; determining whether a second condition is met with respect to at least one of the one or more second LCHs; and adjusting a priority of the first LCH based on detecting the first condition and determining whether the second condition is met.

Example 16 includes the method of example 15 or some other example herein, wherein the subset of one or more second LCHs includes the one or more other LCHs that: are included in a pre-configured list; have a default or adjusted priority that is greater than the respective default priority or first boosted priority of the first LCH; have a default or adjusted priority of at least a threshold level; have a bit rate metric that is greater than a bit rate metric of the first LCH; have a bit rate metric of at least a threshold value; have a configured boosted priority; or are associated with data radio bearers that have activated protocol data unit (PDU) set importance (PSI)-based discarding.

Example 17 includes the method of example 16 or some other example herein, wherein the boosted priority is a first boosted priority, and wherein adjusting the priority of the first LCH includes: adjusting the priority of the first LCH to the first boosted priority based on determining that the second condition is not met with respect to at least one of the one or more second LCHs; or adjusting the priority of the first LCH to a second boosted priority based on determining that the second condition is met with respect to at least one of the one or more second LCHs, wherein the second boosted priority is lower than the first boosted priority.

Example 18 includes the method of example 15 or some other example herein, wherein the buffer is a first buffer, wherein the threshold is a first threshold, and wherein the second condition includes: whether a volume of delay-critical data in a second buffer associated with the at least one second LCH is greater than a second threshold; whether a volume of important data in the second buffer with at least a threshold importance level is greater than a third threshold; whether a volume of delay-critical data and important data in the second buffer is greater than a fourth threshold; or wherein a bit rate metric of the second LCH is greater than a fifth threshold.

Example 19 includes the method of example 15 or some other example herein, wherein the second condition includes that a metric of the at least one second LCH is worse than a corresponding metric of the first LCH.

Example 20 includes the method of example 19 or some other example herein, wherein the metric includes a volume of delay-critical data, a volume of important data with at least a threshold importance level, a volume of delay-critical data and important data, or a bit rate metric.

Another example may include an apparatus comprising means to perform one or more elements of a method described in or related to any of examples 1-20, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Another example may include an apparatus comprising logic, modules, or circuitry to perform one or more elements of a method described in or related to any of examples 1-20, or any other method or process described herein.

Another example may include a method, technique, or process as described in or related to any of examples 1-20, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-20, or portions thereof.

Another example may include a signal as described in or related to any of examples 1-20, or portions or parts thereof.

Another example may include a datagram, information element, packet, frame, segment, PDU, or message as described in or related to any of examples 1-20, or portions or parts thereof, or otherwise described in the present disclosure.

Another example may include a signal encoded with data as described in or related to any of examples 1-20, or portions or parts thereof, or otherwise described in the present disclosure.

Another example may include a signal encoded with a datagram, IE, packet, frame, segment, PDU, or message as described in or related to any of examples 1-20, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Another example may include a computer program comprising instructions, wherein execution of the program by a processing element is to cause the processing element to carry out the method, techniques, or process as described in or related to any of examples 1-20, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
receiving a packet from an upper layer;
storing the packet in a buffer of a logical channel (LCH) for transmission;
determining that the packet has experienced jitter greater than a threshold prior to receiving the packet; and
adjusting, based on the determining, a priority of the packet or the LCH from a default priority to a boosted priority that is greater than the default priority.

2. The method of claim 1, further comprising receiving a configuration of the boosted priority.

3. The method of claim 1, wherein adjusting the priority includes adjusting the priority for all packets in the LCH.

4. The method of claim 1, wherein adjusting the priority includes adjusting the priority includes adjusting the priority for the packet while maintaining the default priority for at least one other packet stored in the buffer.

5. The method of claim 1, wherein the buffer is a first buffer, the LCH is a first LCH, and wherein adjusting the priority is based further on whether there is delay-critical data in a second buffer of a second LCH, wherein the delay-critical data includes data that has experienced jitter greater than the threshold or that has a remaining time less than a remaining time threshold.

6. An apparatus comprising:
processor circuitry to:
detect a first condition based on a determination that at least one packet within a buffer associated with a first logical channel (LCH) has a remaining time until discard below a threshold, wherein the first LCH is configured with a default priority and a first boosted priority;
detect whether a second condition is met with respect to at least one second LCH; and
adjust, based on detecting the first condition, a priority of the first LCH from the default priority to the first boosted priority or a second boosted priority, wherein the first or second boosted priority is selected based on whether the second condition is met with respect to the at least one second LCH; and
interface circuitry coupled to the processor circuitry to enable communication.

7. The apparatus of claim 6, wherein to adjust the priority of the first LCH includes to adjust the priority of the first LCH to the second boosted priority based on detecting that the second condition is met for the at least one second LCH, wherein the second boosted priority is lower than the first boosted priority.

8. The apparatus of claim 6, wherein the buffer is a first buffer, wherein the threshold is a first threshold, and wherein the second condition includes:
whether a volume of delay-critical data in a second buffer associated with the at least one second LCH is greater than a second threshold;
whether a volume of important data in the second buffer with at least a threshold importance level is greater than a third threshold;
whether a volume of delay-critical data and important data in the second buffer is greater than a fourth threshold; or
wherein a bit rate metric of the second LCH is greater than a fifth threshold.

9. The apparatus of claim 6, wherein the second condition includes that a metric of the at least one second LCH is higher or lower than a corresponding metric of the first LCH.

10. The apparatus of claim 9, wherein the metric includes a volume of delay-critical data, a volume of important data with at least a threshold importance level, a volume of delay-critical data and important data, or a bit rate metric.

11. The apparatus of claim 9, wherein the processor circuitry is further to adjust at least one other parameter of the first LCH based on detecting the first condition and detecting whether the second condition is met, wherein the at least one other parameter includes a prioritized bit rate (PBR) or a bucket size duration (BSD).

12. The apparatus of claim 9, wherein the adjusted priority applies to a subset of packets in the buffer.

13. The apparatus of claim 9, wherein the second boosted priority is:
configured for the first LCH;
a predetermined value;
determined based on a first offset with reference to the default priority or the first boosted priority; or
determined based on a second offset with reference to a priority of the at least one second LCH.

14. The apparatus of claim 9, wherein the at least one second LCH is included in a subset of at least one LCH other than the first LCH, wherein the subset of at least one LCH includes at least one LCH that:
is included in a pre-configured list;
has a default or adjusted priority that is greater than the respective default priority or first boosted priority of the first LCH;
has a default or adjusted priority of at least a threshold level;
has a bit rate metric that is greater than a bit rate metric of the first LCH;
has a bit rate metric of at least a threshold value;
has a configured boosted priority; or
is associated with a data radio bearer that has activated protocol data unit (PDU) set importance (PSI)-based discarding.

15. One or more non-transitory, computer-readable media having instructions that, when executed, cause processor circuitry to:
detect a first condition based on a determination that at least one packet within a buffer associated with a first logical channel (LCH) has a remaining time until discard below a threshold, wherein the first LCH is configured with a default priority and a boosted priority;
identify a subset of at least one second LCH, wherein the subset includes less than all other LCHs associated with transmission at a same protocol layer as the first LCH;
determine whether a second condition is met with respect to at least one of the at least one second LCH; and
adjust a priority of the first LCH based on detecting the first condition and determining whether the second condition is met.

16. The one or more non-transitory, computer-readable media of claim 15,
wherein the subset of at least one second LCH includes the at least one other LCH that:
is included in a pre-configured list;
has a default or adjusted priority that is greater than the respective default priority or first boosted priority of the first LCH;
has a default or adjusted priority of at least a threshold level;
has a bit rate metric that is greater than a bit rate metric of the first LCH;
has a bit rate metric of at least a threshold value;
has a configured boosted priority; or
is associated with a data radio bearer that has activated protocol data unit (PDU) set importance (PSI)-based discarding.

17. The one or more non-transitory, computer-readable media of claim 16, wherein the boosted priority is a first boosted priority, and wherein to adjust the priority of the first LCH includes to:
adjust the priority of the first LCH to the first boosted priority based on determining that the second condition is not met with respect to at least one of the at least one second LCH; or
adjust the priority of the first LCH to a second boosted priority based on determining that the second condition is met with respect to at least one of the at least one second LCH, wherein the second boosted priority is lower than the first boosted priority.

18. The one or more non-transitory, computer-readable media of claim 15, wherein the buffer is a first buffer, wherein the threshold is a first threshold, and wherein the second condition includes:
whether a volume of delay-critical data in a second buffer associated with the at least one second LCH is greater than a second threshold;
whether a volume of important data in the second buffer with at least a threshold importance level is greater than a third threshold;
whether a volume of delay-critical data and important data in the second buffer is greater than a fourth threshold; or
wherein a bit rate metric of the at least one second LCH is greater than a fifth threshold.

19. The one or more non-transitory, computer-readable media of claim 15, wherein the second condition includes that a metric of the at least one second LCH is worse than a corresponding metric of the first LCH.

20. The one or more non-transitory, computer-readable media of claim 19, wherein the metric includes a volume of delay-critical data, a volume of important data with at least a threshold importance level, a volume of delay-critical data and important data, or a bit rate metric.
